(19) United States
(12) Patent Application Publication
(10) Pub. No.: US 2014/0167979 A1
(43) Pub. Date: Jun. 19, 2014

(54) SMART METER SYSTEM, MANAGEMENT ROUTER, AND METER

(71) Applicant: Mitsubishi Electric Corporation, Chiyoda-ku (JP)

(72) Inventors: Shingo SOMA, Tokyo (JP); Koichi Matsukawa, Tokyo (JP)

(73) Assignee: Mitsubishi Electric Corporation, Chiyoda-ku (JP)

(21) Appl. No.: 13/966,786

(22) Filed: Aug. 14, 2013

(30) Foreign Application Priority Data
Dec. 17, 2012 (JP) 2012-274540

(51) Int. Cl. G08C 15/00

(52) U.S. Cl. CPC G08C 15/00
USPC 340/870.02

(57) ABSTRACT

Management routers perform control for performing a prefix information delegation request for requesting a management server to delegate the management of prefix information, receiving, as a response to the prefix information delegation request, prefix information management delegation from the management server, and delegating the management of the prefix information within a range of management delegation from the management server in response to a prefix information delegation request from meters. The meters perform control for transmitting a prefix information delegation request to the management routers, receiving prefix information management delegation from the management routers as a response to the prefix information delegation request, and notifying a home apparatus in a home network connected to the meters of the prefix information, the management of which is delegated from the management routers.

### BACKGROUND OF THE INVENTION

1. Field of the Invention

The present invention relates to a smart meter system.

2. Description of the Related Art

In an Internet protocol (IP) communication network, a host network to which a server and the like are connected and a network connected to a router and present beyond the router are different networks. A global address of IPv6 can directly designate a Pv6 address of a terminal present in the network connected to the router. Therefore, there is a demand for setting of related prefixes in a network before a relay by a relaying router and a network after the relay.

A router at a delivery source of prefix information manages a wide range of prefix information, which is network addresses of IPv6, to associate the prefix information. The router at the delivery source delegates the management of a part of the prefix information in the management range to a router at a delivery destination. Consequently, the router at the delivery destination can create a network affixed with a prefix related to a network managed by the router at the delivery source.

When a plurality of routers are present, in networks connected to the routers, prefixes need to be included in the networks managed by the router at the delivery source and independent from the networks connected to the other routers. Therefore, the routers are not allowed to freely create and determine prefixes.

Therefore, the router at the delivery source delegates the management of prefix information. Concerning the management delegation, it is a general practice to use Dynamic Host Configuration Protocol Version 6-Prefix Delegation (DHCPv6-PD). However, because a sequence of DHCPv6 is a method for searching for a server in multicast, in a multi-hopping network including a large number of terminals such has a mesh network, a multicast message changes to a broadcast message flowing to the entire mesh network. Therefore, there is a concern over congestion.

To avoid the congestion, for example, Japanese Translation of International Patent Application No. 2009-500970 discloses a technology for notifying, when a plurality of user terminals are present under a router at a delivery destination in an Ethernet (registered trademark) of a wired network, the respective terminals of different kinds of prefix information by using IDs of the terminals in a router request (RS) message and a router advertisement (RA) message.

However, according to the technology in the past, the network is the wired Ethernet and, when a large number of networks are present beyond one router, terminal apparatuses beyond the router give IDs of the apparatuses to router request (RS) messages and receive router response (RA) messages exclusive for the apparatuses as responses to the router request (RS) messages, i.e., the router response (RA) messages are sent to only a specific line of the router. Therefore, the technology cannot be applied to a network having a high packet loss ratio such as a wireless mesh network.

### SUMMARY OF THE INVENTION

It is an object of the present invention to at least partially solve the problems in the conventional technology.

A smart meter system adapted to IPv6 according to an aspect of the present invention includes: a management router configured to relay communication between a host network and a subordinate mesh network; and a plurality of meters configured to establish the mesh network in conjunction with the management router. The management router performs control for performing a prefix information delegation request for requesting the management server, which is connected through the host network, to delegate management of prefix information of an address usable in the mesh network, receiving, as a response to the prefix information delegation request, prefix information management delegation, which is prefix information in a range of management delegation to the management router, from the management server, and delegating the management of the prefix information within a range of management delegation from the management server in response to a prefix information delegation request from the meter. The meter performs control for transmitting a prefix information delegation request to the management router, receiving prefix information management delegation from the management router as a response to the prefix information delegation request, and notifying a home apparatus in a home network connected to the meter of the prefix information, the management of which is delegated from the management router.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration example of a network system according to a first embodiment;

FIG. 2 is a diagram of a configuration example of a meter;

FIG. 3 is a diagram of a configuration example of a meter;

FIG. 4 is a diagram of a configuration example of a management router;

FIG. 5 is a diagram of a format example of a delegation request option for prefix information included in NS/RS messages;

FIG. 6 is a diagram of a format example of a delegation request option for prefix information included in NA/RA messages;

FIG. 7 is a sequence chart of processing for performing prefix delegation between a management router and a 1-Hop neighboring meter;

FIG. 8 is a sequence chart of processing for performing prefix delegation between the management router and a meter apart from the management router more than 1-Hop;

FIG. 9 is a diagram of a configuration example of a network system according to a fourth embodiment;

FIG. 10 is a diagram of a configuration example of the network system according to the fourth embodiment;

FIG. 11 is a sequence chart for performing notification of prefix delegation information between a management router and a 1-Hop neighboring meter; and

FIG. 12 is a sequence chart for performing notification of prefix delegation information between the management router and a meter apart from the management router more than 1-Hop.

### DETAILED DESCRIPTION OF THE PREFERRED EMBODIMENTS

Exemplary embodiments of the present invention are explained in detail below with reference to the accompanying drawings. The present invention is not limited by the embodiments.

### First Embodiment

First, in a network system in the past including a network to which a management server is connected and a home network to which a home apparatus is connected, a specific example in a system that delegates a prefix and a problem of the system are briefly explained.

For example, a system is conceivable in which an electric power company directly performs output control (for stabilization of a system voltage) for a power conditioning subsystem (PCS) or directly accesses a home apparatus and perform home energy management system (HEMS) control (demand response) in a home and acquires information from a sensor.

In a management server of the electric power company, because the home apparatus is directly designated by an IP to perform communication, a consistent address system needs to be adopted from a network of the management server to the home network and networks independent from the other networks (independent prefix) need to be set.

When a model is assumed in which a management router (a gateway (GW)/concentrator) directly connected to a management server by a wired network communicates with subordinate routers (smart meters) by 920 MHz specified low power radio, the routers (the smart meters) subordinate to the management router establish a mesh network by the 920 MHz specified low power radio. Further, the routers (the smart meters) play a role of a management router in a home and communicate with home apparatuses (a PCS, a HEMS a sensor, and the like) using communication media such as the 920 MHz specified low power radio, power line communication (PLC), WiFi, and an Ethernet.

For the management server to directly control the home apparatuses, IPv6 global addresses/unique local addresses that can be directly designated by an IP layer from the management server to the home apparatuses need to be set to the home network through an IPv6 over Low power Wireless Personal Area Networks (6LoWPAN) mesh network of the 920 MHz specified low power radio, which is a Lossy Network having a high packet loss ratio.

For the management server to delegate prefix information to a router through a network (Lossy Network) having high packet loss ratio and set a prefix of IPv6 independent from a home network managed by the router, the management server needs to perform prefix delegation in a sequence having a small number of messages.

A network system including a smart meter system according to this embodiment that can delegate prefix information through a network having a high packet loss ratio is explained.

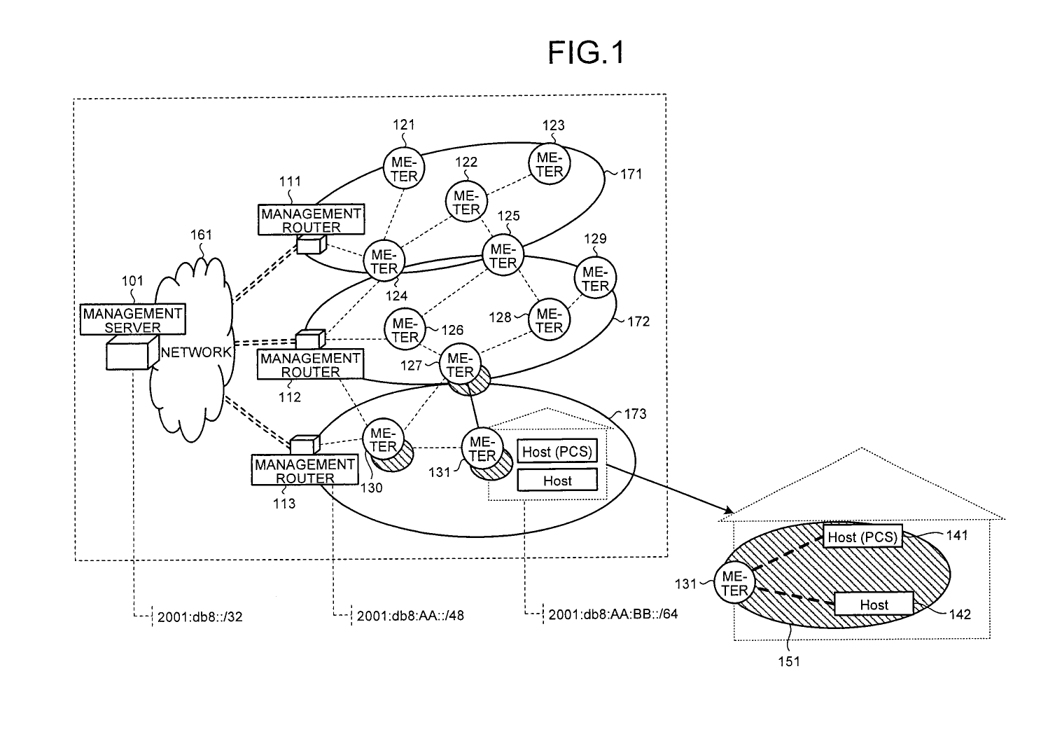

FIG. 1 is a diagram of a configuration example of a network system according to this embodiment. The network system includes a management server 101, management routers 111 to 113, meters 121 to 131, a network 161, and mesh networks 171 to 173.

The management server 101 is connected to the management routers 111 to 113 through the network 161. In response to delegation requests for prefix information from the management routers 111 to 113, the management server 101 delegates the management of prefix information managed by the management server 101.

The management routers 111 to 113 establish mesh networks in conjunction with a plurality of meters. The management routers 111 to 113 operate as coordinators in the mesh networks, manage the prefix information, the management of which is delegated from the management server 101, and, in response to prefix delegation requests from the meters included in the mesh networks, further delegate the management of a part of the prefix information, the management of which is delegated. In the following explanation, when the management routers are not specified, reference numerals are sometimes not affixed.

The prefix information managed by the management routers 111 to 113 include prefix information usable in the mesh networks subordinate to the management routers and a part of prefix information, the management of which can be delegated to the meters subordinate to the management routers 111 to 113.

For example, in FIG. 1, when the management server 101 manages prefix information in a range “2001:db8::/32”, the management server 101 delegates the management of a part of the prefix information to the management router 113 and a mesh network 173 subordinate to the management router 113 in a range “2001:db8:AA::/48”. Further, the management router 113 delegates the management of the prefix information to the subordinate meter 131 and a home network 151 subordinate to the meter 131 in a range “2001:db8:AA:BB::/64”, which is a part of the range “2001:db8:AA::/48”.

The management routers 111 to 113 manage prefix information in a range of management delegation by DHCPv6-PD from the host management server 101. For example, when a management router is at the top of a system, the management router itself can independently determine prefix information and manage the prefix information.

The meters 121 to 131 configure the mesh network in conjunction with the other meters and the host management router. The meters can be connected to a home network. For example, the meter 131 establishes a home network 151 in conjunction with Hosts (home apparatuses) 141 and 142. Like the meter 131, the other meters can establish home networks in conjunction with home apparatuses. However, the meters can be terminal apparatuses like the meters 121 to 126, 128, and 129 and do not have to establish home networks in conjunction with home apparatuses. In the following explanation, when the meters are not specified, reference numerals are sometimes not delegated to the meters.

The home network 151 is a network established by the meter 131 and the Hosts 141 and 142. A wireless network is assumed as the home network 151. However, the home network 151 can be a wired network as long as the wired network is an IPv6 network. Further, the home network 151 can be a network capable of using IPv4 together with IPv6.

The network 161 is a network that connects the management server 101 and the management routers 111 to 113. The network 161 is a host network for the management routers 111 to 113. An IPv6 network by wire is assumed as the network 161. However, this is only an example. The network 161 can be a wireless network as long as a prefix delegation request and management delegation are possible or can be a network in which IPv4 can be used together with IPv6.

Each of the mesh networks 171 to 173 is a network including one management router and a plurality of meters. A meter can participate in two or more mesh networks. For example, in the network system shown in FIG. 1, the mesh network 171 is established by the management router 111 and the meters 121 to 125, the mesh network 172 is established by the management router 112 and the meters 124 to 129, and the mesh network 173 is established by the management router 113 and the meters 127, 130, and 131. In this way, each of the meters 124, 125, and 127 participates in two mesh networks.

Configurations of the meters 121 to 131 and the management routers 111 to 113 that establish the mesh networks in the network system shown in FIG. 1 are explained.

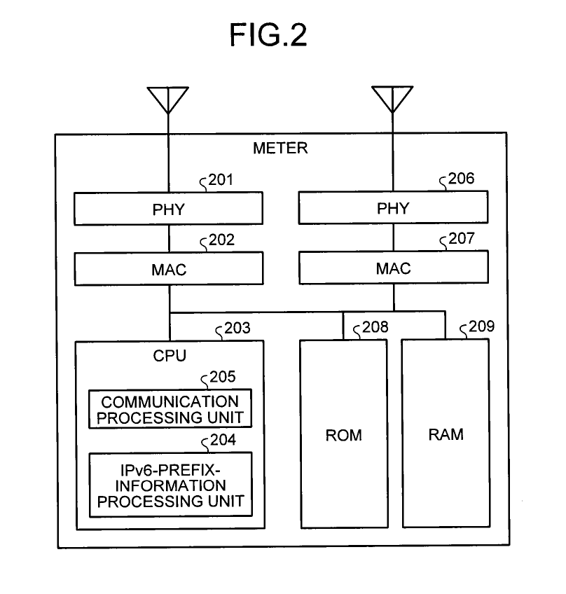

FIG. 2 is a diagram of a configuration example of the meters 121 to 131. Each of the meters 121 to 131 includes a physical (PHY) 201, a media access control (MAC) 202, a central processing unit (CPU) 203, a PHY 206, a MAC 207, a read only memory (ROM) 208, and a random access memory (RAM) 209. The CPU 203 includes an IPv6-prefix-information processing unit 204 and a communication processing unit 205. A configuration including a plurality of physical PHYs is explained.

The PHY 201 is an I/F for connecting the meter to the other meters and the management router that establish the mesh network. The PHY 206 is also an I/F for connecting the meter to home apparatuses. Both of the PHY 201 and the PHY 206 can use specified low power radio in a 920 MHz band or only the PHY 206 can use Wi-Fi radio. The PHY 201 does not have to be the specified low power radio in the 920 MHz band as long as the mesh network can be established.

The MAC 202 controls the PHY 201. The MAC 202 performs the management of a MAC address and performs the management of a 16-bit short address, a 48-bit apparatus-specific MAC address, and a 64-bit EUI-64 MAC address. The lengths of the addresses are not limited as long as the MAC 202 is independent from the other devices as a MAC layer.

The MAC 207 controls the PHY 206. When the specified low power radio in the 920 MHz band is used for the PHY 206, the MAC 207 has a function same as the MAC 202. When Wi-Fi is used for the PHY 206, the MAC 207 performs the management of the 48-bit apparatus-specific MAC address. In the MACs, a control method is changed according to a type of the PHYs.

The CPU 203 carries out various kinds of control processing in the meter. As representative processing, there is the management of prefix information carried out by the IPv6-prefix-information processing unit 204. The IPv6-prefix-information processing unit 204 is information processing means in the meter concerning IPv6 prefix information. Upon receiving a router advertisement (RA) message of IPv6 from the management router through the communication processing unit 205, the IPv6-prefix-information processing unit 204 acquires prefix information, which is option information of the RA message, and carries out processing for using the prefix information as prefix information of an IPv6 address used in the mesh network between the meter and the management router. Upon receiving prefix delegation information included in the RA message or a neighbor advertisement (NA) message from the management router, the IPv6-prefix-information processing unit 204 carries out processing for generating prefix information that can be used in a home network between the meter and home apparatuses and is different from the prefix information on the mesh network side. The communication processing unit 205 controls transmission and reception of various messages through the PHY 201, the MAC 202, the PHY 206, and the MAC 207.

The ROM 208 is a storing unit configured to store prefix information processed by the IPv6-prefix-information processing unit 204 and the communication processing unit 205 and IPV6 address information generated from the prefix information. Information to be stored is not limited to these kinds of information. For example, information concerning a meter 1-Hop ahead in the mesh network and the management router can be stored.

The RAM 209 is a storing unit used for storing temporary information.

In the above explanation, the meter includes the two interfaces. However, for example, as shown in FIG. 1, when the meter is connected to the home network, the meter can include two PHYs and two MACs and, therefore, include two interfaces and, when the meter is not connected to the home network, the meter can include one PHY and one MAC and, therefore, include one interface.

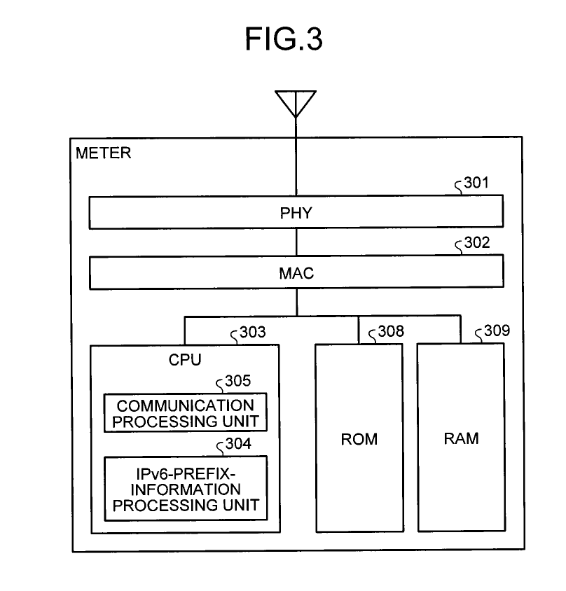

Other configurations of the meters 121 to 131 are explained. FIG. 3 is a diagram of a configuration example of the meters 121 to 131. Each of the meters 121 to 131 includes a PHY 301, a MAC 302, a CPU 303, a ROM 308, and a RAM 309. The CPU 303 includes an IPv6-prefix-information processing unit 304 and a communication processing unit 305. A configuration including one physical PHY is explained.

The PHY 301 is an I/F for connecting the meter to the other meters and the management router that establish the mesh network and for connecting the meter to home apparatuses. In the connection to both of the mesh network side and the home apparatus side, the PHY 301 uses the same transmission medium such as the specified low power radio in the 920 MHz band. A frequency band can be different as long as the frequency band is in a range in which the frequency band can be controlled by the MAC 302. For example, 923 MHz can be used on the mesh network side and 924 MHz can be used on the home apparatus side. The same frequency band can be used on the mesh network side and the home apparatus side.

The CPU 303 carries out various kinds of control processing in the meter. Basically, the CPU 303 carries out processing same as the processing by the CPU 203. Likewise, the IPv6-prefix-information processing unit 304, the communication processing unit 305, the ROM 308, and the RAM 309 respectively carry out processing same as the processing by the IPv6-prefix-information processing unit 204, the communication processing unit 205, the ROM 208, and the RAM 209 shown in FIG. 2.

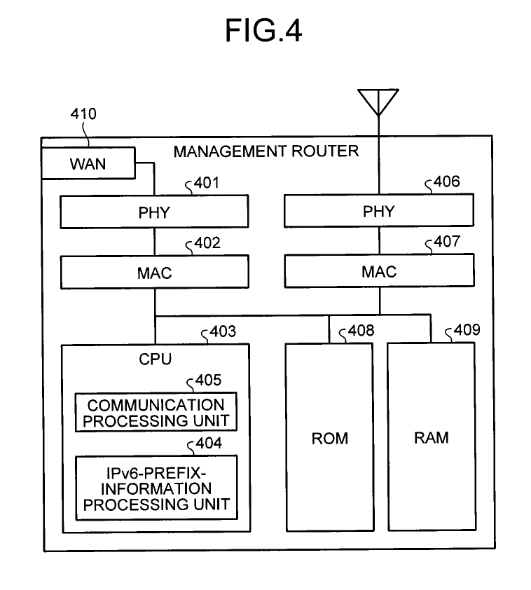

The configuration of the management routers 111 to 113 is explained. FIG. 4 is a diagram of a configuration example of the management routers 111 to 113. Each of the management routers 111 to 113 includes a PHY 401, a MAC 402, a CPU 403, a PHY 406, a MAC 407, a ROM 408, a RAM 409, and a wide area network (WAN) 410. The CPU 403 includes an IPv6-prefix-information processing unit 404 and a communication processing unit 405.

The WAN 410, the PHY 401, and the MAC 402 are I/Fs connected to a wired network on the management server 101 side. Examples of the wired network include an optical fiber and an Ethernet. However, the wired network is not limited to these networks. Other systems can be used as long as the I/Fs can communicate with the management server 101 using an IP.

The PHY 406 and the MAC 407 are I/Fs connected to the network on the meter side that establishes the mesh network. The I/Fs on the side of the WAN 410, the PHY 401, and the MAC 402 and the I/Fs on the side of the PHY 406 and the MAC 407 can use addresses of different protocols.

The CPU 403 carries out various kinds of processing in the management router. The IPv6-prefix-information processing unit 404 is information processing means in the management router concerning IPv6 prefix information. Upon receiving an RA message of IPv6 from the management server 101 side through the communication processing unit 405, the IPV6-prefix-information processing unit 404 receives prefix information, which is option information of the RA message, and carries out processing for using the prefix information as prefix information of an IPv6 address used in the network 161 between the management router and the management server 101. The IPv6-prefix-information processing unit 404 processes prefix information delegated to the management router from the management server 101 using DHCPv6-PD by the communication processing unit 405. The communication processing unit 405 carries out communication protocol processing such as IPv6 or 6LoWPAN. The communication processing unit 405 controls transmission and reception of various messages through the WAN 410, PHY 401, the MAC 402, the PHY 406, and the MAC 407.

The ROM 408 is a storing unit configured to store prefix information processed by the IPv6-prefix-information processing unit 404 and the communication processing unit 405 and IPv6 address information generated from the prefix information. Information to be stored is not limited to these kinds of information. The ROM 408 can store management information in the management router or can store, for example, information concerning a meter 1-HOP ahead in the mesh network.

The RAM 409 is a storing unit used for storing temporary information.

An operation of the meters 121 to 131 requesting the host management router to delegate prefix information and an operation of the host management router delegating the management of the prefix information in the network system is explained.

For example, a meter at a delegation request source can transmit information concerning a delegation request to the host management router while including the information in a neighbor solicitation (NS) message of 6LoWPAN-neighbor discovery (ND) message. The management router can delegate management in response to the delegation request for prefix information from the meter. In this case, the management router returns the prefix information, the management of which is delegated, to the meters at the transmission source while including the prefix information in an NA message of 6LoWPAN-ND.

Alternatively, the meter at the delegation request source can transmit the information concerning a delegation request to the host management router while including the information in a router solicitation (RS) message of 6LoWPAN-ND. The management router can delegate management in response to the delegation request for prefix information from the meter. In this case, the management router returns the prefix information, the management of which is delegated, to the meter at the transmission source while including the prefix information in an RA message of 6LoWPAN-ND.

The prefix information, the management of which is delegated by the management router, is independent prefix information different from prefix information, the management of which is delegated to the other routers. Consequently, the management router can delegate the management of information different from information, the management of which is delegated to the other meters.

Specifically, the management server 101 manages prefix information of an IPv6 global address or an IPv6 unique local address, i.e., prefix information of an IPv6 address usable in the networks (the mesh networks 171 to 173) beyond the management routers 111 to 113. The prefix information managed by the management server 101 is prefix information in a range sufficient for delegating management to each of the management routers 111 to 113 subordinate to the management server 101.

The management server 101 receives delegation requests for prefix information from the management routers 111 to 113 and enables the management of a part of the prefix information managed by the management server 101 to be delegated to the management routers 111 to 113 at delegation request sources of the prefix information. The prefix information, the management of which is delegated to the management routers 111 to 113 from the management server 101, is prefix information in a range sufficient for delegating management to each of the meters subordinate to the management routers.

The management routers 111 to 113 receive delegation requests for prefix information from the subordinate meters and enable the management of a part of the prefix information managed by the management routers 111 to 113 to be delegated to the meters at the delegation request sources of the prefix information. The prefix information, the management of which is delegated to the meters from the host management routers, is used as network information for connecting the meters to home apparatuses subordinate to the meters.

Even when a plurality of home apparatuses are present under the meter, the meter can use different kinds of prefix information for connection to the home apparatuses by using prefix information, the management of which is delegated. That is, the meter can use different networks between the meter and the home apparatuses. A method of using prefix information is not limited to this method. For example, all the home apparatuses and the meter can be formed as one network and use the same prefix information or a part of the home apparatuses can be grouped and, in a unit of the group, prefix information different from prefix information of the other group can be used.

The management routers 111 to 113 can have a function of a DHCPv6 server to manage prefix information. The management routers 111 to 113 can leave the function of the DHCPv6 server to the servers and the like connected to the host network. In this case, the management routers 111 to 113 can cooperate with the DHCPv6 server, for example, learn an address and the location of the DHCPv6 server. A function of the management routers 111 to 113 is not limited to the function of the DHCPv6 server as long as the management routers 111 to 113 can manage the prefix information. For example, the management routers 111 to 113 can use a database. The management routers 111 to 113 can use a plurality of databases or DHCPv6 servers rather than one database or one DHCPv6 server.

In this embodiment, a transmission medium having a large communication loss such as the specified low power radio in the 920 MHz band or a PLC is used as a transmission medium between the management routers 111 to 113 and the meters. In the specified low power radio in the 920 MHz band, a form of a mesh network is adopted in which a plurality of meters establish a mesh network and establish communication path to the management routers 111 to 113. To use IP in this mesh network, an IP system is adopted in which a protocol of 6LoWPAN+IPv6 that takes into account Lowe transmission efficiency (a high loss ratio) is used.

When sufficient transmission efficiency is kept, it is also possible to adopt a system of only IPv6. In a network in which the 6LoWPAN+IPv6 protocol is used, a 6LoWPAN-ND protocol obtained by adapting the ND protocol of IPv6 to a network characteristic of a low transmission efficiency is used. In this embodiment, the 6LoWPAN-ND protocol is improved. A procedure for delegation of prefix information is carried out between the management routers 111 to 113 and the meters by (1) a method of using 6LoWPAN NS/NA messages and (2) a method of using 6LoWPAN RS/RA messages.

(1) Method of Using 6LoWPAN NS/NA Messages

The meter subordinate to the management router can request the management router to delegate IPv6 prefix information. As a delegation request method for the IPv6 prefix information, NS/NA messages of 6LoWPAN-ND are used. That is, the meter transmits a prefix information delegation request while including the prefix information delegation request in option information of an NS message. The management router returns prefix information management delegation while including the prefix information management delegation in option information of an NA message in response to the prefix information delegation request included in the option information of the NS message.

In a sequence between the management router and the meter employing the 6LoWPAN-ND protocol, first, to request a redundancy check of an IPv6 address of the meter, the meter starts the sequence by multi-hop transferring an NS message to the management router while including a delegation request option of prefix information in the NS message. As a method of setting the IPv6 address, the IPv6 address can be set by a method same as a method described in 6LoWPAN-ND.

An overview of the method of setting the IPv6 address in 6LoWPAN-ND is explained. First, the management router distributes prefix information used in a network between the management router and the meter while including the prefix information in an RA message as option information. The management router can transmit the RA message as a response to an RS message from the meter or can periodically transmit the RA message. When a mesh network is established according to 6LoWPAN-ND, the transmission of the RS message from the meter can be only to the 1-hop neighbor in 1-Hop multicast. The transmission of the RA message from the management router can also be only to the 1-hop neighbor in unicast to the meter that transmits the RS message.

The meter receives the RA message from the management router and generates an IPv6 address of the meter in a provisional state from an option of the prefix information of RA. The meter uses NS/NA messages of 6LoWPAN-ND to change the provisional state to a usable state. The meter includes the IPv6 address in the provisional state in an NS message and transmits, as a redundancy check request, the NS message including the IPv6 address in the provisional state to the management router through multi-hop duplicate address detection (DAD). At this point, the meter includes an option of a delegation request for prefix information in the NS message to request the management router to deliver prefix information for use in a home network or the like other than a network between the management router and the meter.

When it is necessary to perform multi-hop between the meter that performs the redundancy check request for the IPv6 address and the delegation request for the prefix information and the management router that responds to the requests, nodes and routers through which the requests are transmitted deliver request information to the management router without changing the request information.

The sequence between the management router and the meter employing the 6LoWPAN-ND protocol is explained again. Upon receiving the NS message including the redundancy check request and the delegation request option for prefix information from the meter, the management router returns an NA message as a response to the NS message. When the management of the prefix information can be delegated, the management router notifies prefix information in a delegatable range together with a result for the redundancy check request while including the prefix information as an option in the NA message.

When the meter at the request source is a 1-Hop neighboring meter, the management router delivers the NA message including the option of the prefix information to the meter at the request source by multi-hop. A route for the delivery can be a route same as or different from a route of the NS message as long as the NA message can be returned to the meter at the request source.

When it is necessary to perform multi-hop between the management router that transmits the NS message and the meter at the transmission source of the NA message, nodes and routers through which information such as the prefix delegation information are transmitted deliver the information to the meter at the transmission source of the NA message without changing contents of the information.

When it is determined as a result of the redundancy check that there is no redundancy, the meter that receives the NA message changes the IPv6 address in the provisional state to a usable state. When the prefix delegation information is included as a delegatable state, the meter stores the prefix delegation information as prefix delegation information that the meter can manage.

The meter that receives the NA message can use the prefix delegation information for a home network. As a notification method for using the prefix delegation information in the home network, an RA message can be used. As a method of transmitting the RA message, for example, the meter can periodically transmit the RA message by multicast or, upon receiving an RS message from a subordinate home terminal, the meter can transmits the RA message as a response to the RS message.

(2) Method of Using 6LoWPAN RS/RA Messages

The meter subordinate to the management router can request the management router to delegate IPv6 prefix information. As a method of requesting delegation of IPv6 prefix information from the meter at the request source to the management router, the meter uses an RS message of 6LoWPAN-ND. As a method of delegating IPv6 prefix information from the management router to the meter at the request source, the management router uses an RA message. That is, the meter transmits the RS message while including a prefix information delegation request in option information of the RS message. The management router returns prefix information management delegation in response to the prefix information delegation request included in the option information of the RS message while including the prefix information management delegation in option information of the RA message.

The management router enables allocation of an address of a MAC layer independent in a network to the meter. The address only has to be independent in the same network. As the address of the MAC layer, for example, 16-bit short address defined in IEEE 802.15.4 can be used. When a personal area network (PAN) configured in IEEE 802.15.4 is assumed, the management router plays a role of a PAN coordinator and allocates a 16-bit short address to a node in the PAN. The 16-bit short address indicates an address usable as a MAC layer.

In the case of a system in which the management router cannot allocate a 16-bit short address to the meter, the meter can create a 16-bit short address by itself. The length of the address of the MAC layer including a short address is not limited to 16 bits.

The meter owns the independent address or the 16-bit short address and enables the address to be used as an address of the MAC layer. The 16-bit short address is based on the premise that the 16-bit short address does not overlap addresses of the other meters and nodes in the same network.

When the 16-bit short address is allocated from the management router, after starting in a mesh network of 6LoWPAN, the meter can be allocated with the 16-bit short address while carrying out association processing with the management router, which is processing in the MAC layer.

When the meter independently creates a 16-bit short address, the meter carries out a redundancy check request to the management router.

The network including the management router and the meters is a network that allows use of an independent address of the MAC layer or use of a 16-bit short address as an address of the MAC layer and use of an IPv6 address.

As a method of notifying the meters of prefix information of IPv6 used between the management router and the meters, the management router can use prefix information option in an RA message in Internet control message protocol of IPV6 (ICMPv6) or can further include option information expanded by an RA message in the 6LoWPAN-ND in the prefix information. In the network including the management router and the meters, other methods can be used as long as common prefix information is delivered from the management router to the meters.

Specifically, the meter includes an option indicating a prefix delegation request in an RS message transmitted to the management router.

The management router receives the RS message including the prefix delegation request option and selects a part of a prefix delegatable range managed by the management router. When the prefix delegatable range is determined, the management router returns information concerning the prefix delegatable range to the meter while including the prefix delegatable range in an RA message.

After determining the prefix delegatable range, the meter that receives the RA message adds a short address of the meter to the prefix delegatable range and creates new prefix information.

For example, when a prefix delegation range “A:B:C::/48” is indicated by the management router and the meter has a short address “0xXXXX”, the meter generates a new prefix “A:B:C:XXXX::/64”. The meter can use the new generated prefix information as, for example, home network information in the home of the meter other than the network between the management router and the meter.

The meter can request the management router to perform a redundancy check concerning the prefix information created anew based on the prefix delegatable range from the management router. To request the management router to perform a redundancy check, the meter can use NS/NA messages by multi-hop DAD or duplicate address registration (DAR)/duplicate address confirmation (DAC) messages.

The meter transmits a redundancy check option for prefix information to the management router together with an option of a redundancy check for an IPv6 address while including the redundancy check option in an NS message. When a router 1-hop ahead is not the management router, the meter transmits the redundancy check option to the management router by multi-hop using a DAR message in the multi-hop DAD.

When the redundancy check for the prefix information is completed, the management router that receives the NS message transmits a state of the redundancy check to the meter at the transmission source while including the state of the redundancy check in an NA message or a DAC message.

After the redundancy check in the management router is completed, the meter can use the IPv6 address. The meter can use the IPv6 address as prefix information in a network other than the network between the management router and the meter.

In this way, in the network system according to this embodiment, the management router can determine the prefix delegation request included the NS message from the meter and perform, as a response to the prefix delegation request, delegation of the management of the prefix information to the meter using the NA message.

Alternatively, the management router can determine the prefix delegation request included in the RS message from the meter and perform, as a response to the prefix delegation request, delegation of the management of the prefix information to the meter using the RA message.

A method of performing delegation of the management of the prefix information is not limited to the method in which the management router responds to a request from the meter. For example, the management router can perform delegation of the management of the prefix information by periodically transmitting the RA message including the prefix delegation information to the meter.

A format of the management delegation option for the prefix information included in the NS/RS messages and NA/RA messages is explained.

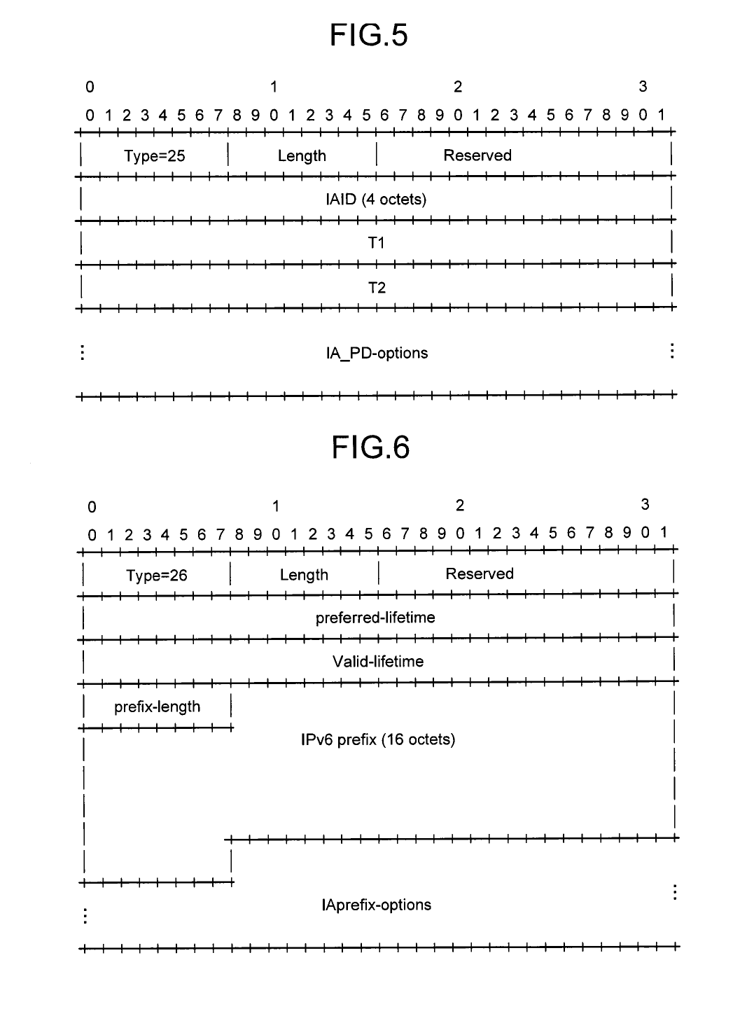

FIG. 5 is a diagram of a format example of the delegation request option for the prefix information included in the NS message or the RS message.

The prefix delegation request option is specified in DHCPv6-PD. However, because DHCPv6 is a message on a user datagram protocol (UDP) and the NS message and the RS message are messages on ICMPv6, formats of the messages are different. Therefore, in FIG. 5, an example in which, in the NS message or the RS message, a PD option of DHCPv6-PD is changed to an option format of ICMPv6 is shown. In FIG. 5, the bottom row is a region of the option.

As the prefix delegation request option, contents of the prefix delegation request only have to be included and a term of validity and the like set when delegation of the management of the prefix information is performed only have to be included.

The format shown in FIG. 5 is an example. The format of the prefix delegation request option is not limited to this form. Formats of other forms can also be used as long as the formats can be recognized between the meter and the management router and can be included in the NS message and the RS message.

FIG. 6 is a diagram of a format example of a management delegation option of prefix information included in the NA message or the RA message.

As in the NS message and the RS message, as the prefix management request option, contents of the prefix management request only have to be included and a term of validity and the like set when delegation of the management of the prefix information is performed only have to be included. In FIG. 6, the bottom row is a region of the option.

The format shown in FIG. 6 is an example. The format of the prefix delegation request option is not limited to this form. Formats of other forms can also be used as long as the formats can be recognized between the meter and the management router and can be included in the NA message and the RA message.

As explained above, according to this embodiment, the management router performs control for performing a prefix information delegation request for requesting the management server to delegate the management of prefix information of an address usable in the mesh network, receiving, as a response to the prefix information delegation request, prefix information management delegation, which is prefix information in a range of management delegation to the management router, from the management server, and delegating the management of the prefix information within a range of management delegation from the management server in response to a prefix information delegation request from the meter. The meter performs control for transmitting a prefix information delegation request to the management router, receiving prefix information management delegation from the management router as a response to the prefix information delegation request, and notifying home apparatuses in a home network connected to the meter of the prefix information, the management of which is delegated from the management router. Consequently, it is possible to delegate the prefix information from the management router side to the meter side without causing congestion in a network having a high packet loss ratio.

In this embodiment, the management router stores the prefix information, the management of which is delegated. When the management router delegates the management of the prefix information to a certain meter, the management router does not delegate the management of the same prefix information to the other meters. However, the control by the management router is not limited to this. For example, the management router can record time information of management delegation for each piece prefix information and not delegate the management of the same prefix information to the other meters before a specified time elapses, i.e., delegate the management of the same prefix information to the other meters after the specified time elapses. When the management router receives the prefix information delegation request again from the same meter, to which the management of the prefix information is delegated, before the specified time elapses, the management router can update the time information.

### Second Embodiment

In a second embodiment, in the network system explained in the first embodiment, an operation for performing prefix delegation between a management router and a 1-Hop neighboring meter is specifically explained.

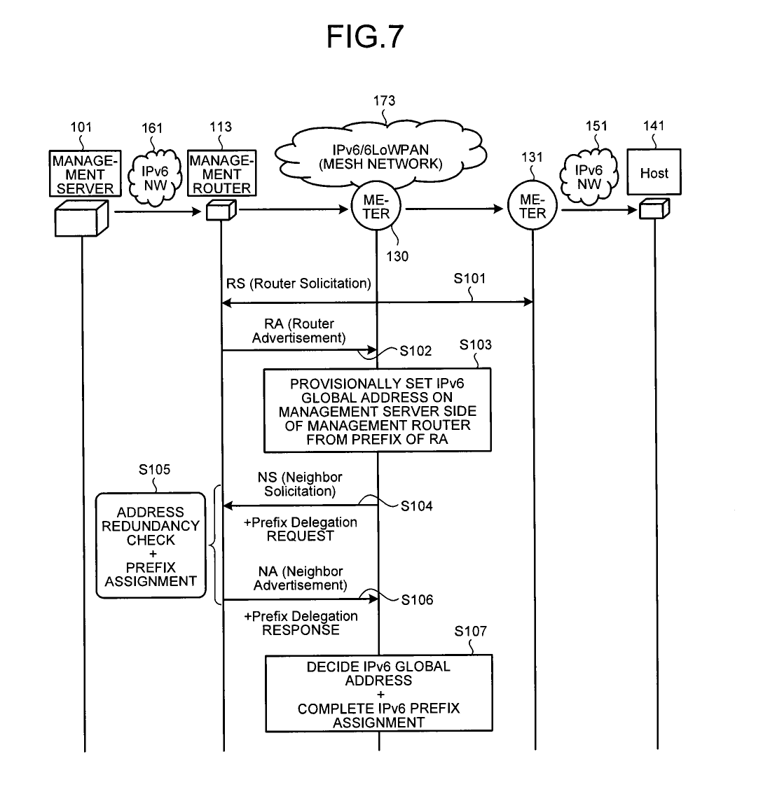

FIG. 7 is a sequence chart of processing for performing prefix delegation using NS/NA messages between the management router and the 1-Hop neighboring meter. As an example, in FIG. 1, prefix delegation is performed between the management router 113 and the meter 130 in a flow of communication from the management server 101 to the management router 113, the meter 130, the meter 131, and the Host 141.

First, the meter 130 searches for a management router in the neighborhood through multicast transmission of an RS message (step S101).

Upon receiving the RS message, the management router 113 transmits by unicast, as a response to the RS message, an RA message including prefix information to the meter 130 (step S102).

The meter 130 receives the RA message and generates, based on the prefix information included in the RA message, in a provisional state, an IPv6 address used in a network (the mesh network 173) between the management router 113 and the meter 130 (step S103).

The IPv6 address in the provisional state depends on the prefix information. The IPv6 address can be either a global address or a unique local address. As an ID section of the IPv6 address (a prefix+the ID section), an ID in an EUI-64 form can be used. However, the ID section is not limited to this. For example, the meter 130 itself can independently determine an ID referring to some information or can independently determine an ID at random. A method of creating the ID section is not limited.

To carry out a redundancy check for the IPv6 address in the provisional state, the meter 130 requests the management router 113 to perform a redundancy check by an NS message of 6LoWPAN-ND (step S104). When the meter 130 has a home network with a Host (a home apparatus), the meter 130 requests the management router 113 to delegate a prefix while including a delegation request option for prefix information in an NS message together with the redundancy check.

The management router 113 receives the NS message including the address redundancy check request and the option of the prefix delegation request, performs a redundancy check of an IPv6 address, and determines a range in which the management of a part of prefix information managed by the management router 113 to the meter 130 at the request source (step S105). A condition under which the management router 113 can delegate the management of the prefix information to the meter 130 is that the management router 113 has a range in which management is not delegated to the other meters in a range managed by the management router 113. When a range in which management can be delegated still remains, a part of the range is set as the range in which management is delegated to the meter 130 at the request source.

After determining the range in which management is delegated, the management router 113 transmits an NA message, which is a response to the NS message, to the meter 130 while including the range of the prefix management delegation together with a result of the redundancy check for the IPv6 address of the meter 130 in the NA message (step S106).

The meter 130 receives the NA message and, when there is no redundancy as a result of the redundancy check, performs processing for changing the IPv6 address from the provisional state to the usable state and deciding the IPv6 address. The meter 130 determines delegatable prefix information included in the NA message and performs the management of prefix information delegated as prefix information to be used in a home network subordinate to the meter 130. Consequently, the delegation is completed (step S107).

Concerning a range of the prefix information, the management of which is delegated to the meter 130 by the management router 113, for example, the meter 130 can request information concerning the range while including the information in the prefix delegation request. In this case, the management router 113 can determine the range according to a requested range from the meter 130 or can independently determine the range. The range of delegation of the prefix information is not limited.

As explained above, in this embodiment, the meter generates, based on the prefix information included in the RA message, in a provisional state, the IPv6 address used in the mesh network and requests the management router to check redundancy of the IPv6 address in the provisional state and delegate a prefix using an NS message. The management router transmits a result of the redundancy check of the IPv6 address and a range of the prefix management delegation to the meter while including the result and the range in an NA message. Consequently, it is possible to perform prefix delegation between the management router and the 1-Hop neighboring meter.

### Third Embodiment

In this embodiment, in the network system explained in the first embodiment, an operation for performing prefix delegation between a management router and a meter apart from the management router more than 1-Hop is specifically explained. Multi-hop DAD of NS/NA messages and DAR/DAC messages are explained.

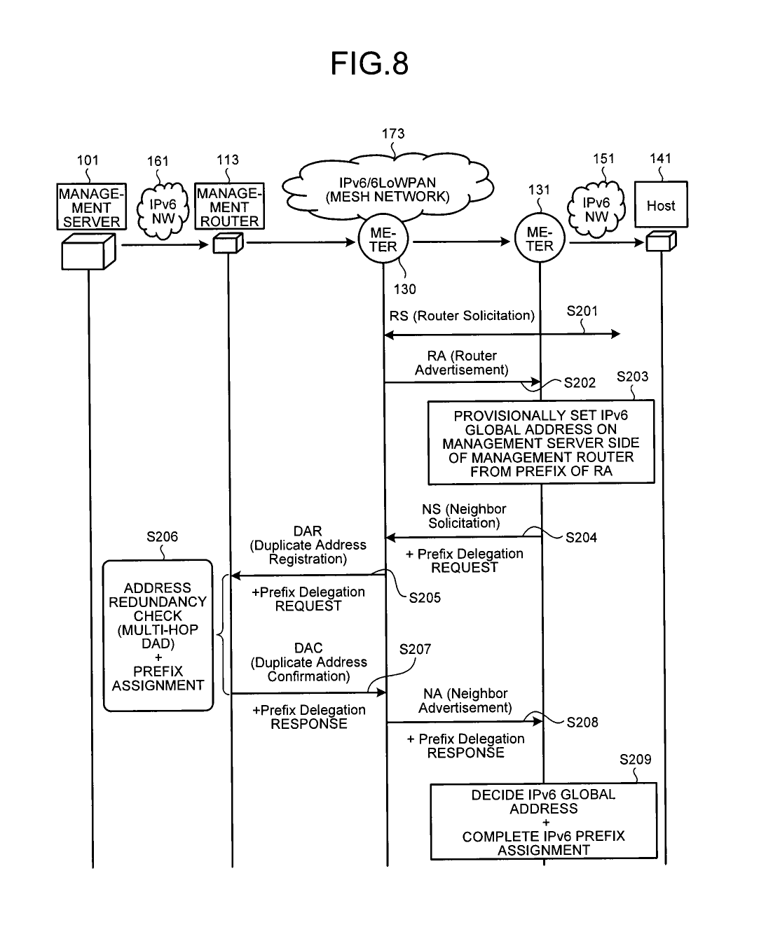

FIG. 8 is a sequence diagram of processing for performing prefix delegation between the management router and the meter apart from the management router more than 1-Hop through the multi-hop DAD of NS/NA messages and DAR/DAC messages. As an example, in FIG. 1, prefix delegation is performed between the management router 113 and the meter 131 in a flow of communication from the management server 101 to the management router 113, the meter 130, the meter 131, and the Host 141.

First, the meter 131 searches for a management router in the neighborhood through multicast transmission of an RS message (step S201).

Upon receiving the RS message, the meter 130, which is a 1-Hop neighboring meter of the management router 113, transmits by unicast, as a response to the RS message, an RA message including prefix information to the meter 131 (step S202). At this point, the meter 130 that allocates prefix information is delegated with prefix information used by the meter 130 and prefix information allocatable to subordinates in advance from the management router 113 or a higher-order meter closer to the management router 113. Consequently, a meter delegated with the management of prefix information can delegate the management of the prefix information in response to a prefix information delegation request from a meter not delegated with the management of prefix information.

The meter 131 receives the RA message and generates, based on the prefix information included in the RA message, in a provisional state, an IPv6 address used in a network (the mesh network 173) between the management router 113 and the meter 131 (step S203).

The IPv6 address in the provisional state depends on the prefix information. The IPv6 address can be either a global address or a unique local address. As an ID section of the IPv6 address (a prefix+the ID section), an ID in an EUI-64 form can be used. However, the ID section is not limited to this. For example, the meter 131 itself can independently determine an ID referring to some information or can independently determine an ID at random. A method of creating the ID section is not limited.

To carry out a redundancy check for the IPv6 address in the provisional state, the meter 131 requests, via the meter 130, the management router 113 to perform a redundancy check by NS/NA and DAR/DAC messages of 6LoWPAN-ND (steps S204 to S208). First, when the meter 131 has a home network with a Host (a home apparatus), the meter 131 requests the meter 130 to delegate a prefix while including a delegation request option for prefix information in an NS message together with the redundancy check (S204).

The 1-Hop neighboring meter 130 receives the NS message including the address redundancy check request and the option of the prefix delegation request and transmits the address redundancy check request and the option of the prefix delegation request included in the NS message to the host management router 113 while replacing the NS message with a DAR message (step S205). The meter 130 multi-hops the DAR message to transmit the DAR message to the management router 113. When the meter 130 is not a 1-Hop neighboring meter, the meter 130 further transmits the DAR message to a higher-order meter.

The management router 113 receives the DAR message attached with the address redundancy check request and the option of the prefix delegation request, performs a redundancy check of an IPv6 address, and determines a range in which the management of a part of prefix information managed by the management router 113 is delegated to the meter 131 at the request source (step S206). A condition under which the management router 113 can delegate the management of the prefix information to the meter 131 is that the management router 113 has a range in which management is not delegated to the other meters in a range managed by the management router 113. When a range in which management can be delegated still remains, a part of the range is set as the range in which management is delegated to the meter 131 at the request source.

After determining the range in which management is delegated, the management router 113 transmits a DAC message, which is a response to the DAR message, to the 1-Hop neighboring meter 130 while including the range of the prefix management delegation in the DAC message together with a result of the redundancy check for the IPv6 address of the 1-Hop neighboring meter 131 of the meter 130 as an option (step S207).

The 1-Hop neighboring meter 130 receives the DAC message and transfers an NA message to the meter 131, which transmits the NS message, while including the result of the redundancy check and the option of the information concerning the prefix delegation included in the DAC message in the NA message instead of the DAC message (step S208). When another meter is still present between the meter 130 and the meter 131, because the meter 130 has received a DAR message from the other meter, the meter 130 transfers the DAC message to the meter.

The meter 131 receives the NA message and, when there is no redundancy as a result of the redundancy check, performs processing for changing the IPv6 address from the provisional state to the usable state and deciding the IPv6 address. The meter 131 determines delegatable prefix information included in the NA message and performs the management of prefix information delegated as prefix information to be used in the home network 151 subordinate to the meter 131. Consequently, the delegation is completed (step S209).

When the prefix information is delegated by multi-hop, as in the second embodiment, concerning a range of the prefix information, the management of which is delegated to the meter 131 by the management router 113, for example, the meter 131 can request information concerning the range while including the information in the prefix delegation request. In this case, the management router 113 can determine the range according to a requested range from the meter 131 or can independently determine the range. The range of delegation of the prefix information is not limited.

As explained above, in this embodiment, the meter transmits option information of an NS message received from another meter to the management router or the next located further on the management router side than the meter while including the option information in the DAR message. The management router detects a prefix information delegation request included in the option information of the DAR message and transmits, as a response to the prefix information delegation request, prefix management delegation to the meter at the transmission source of the DAR message while including the prefix delegation in option information of a DAC message. Consequently, it is also possible to perform prefix delegation between the management router and the meter apart from the management router more than 1-Hop.

### Fourth Embodiment

In a fourth embodiment, a network system that creates a prefix using a short address is explained.

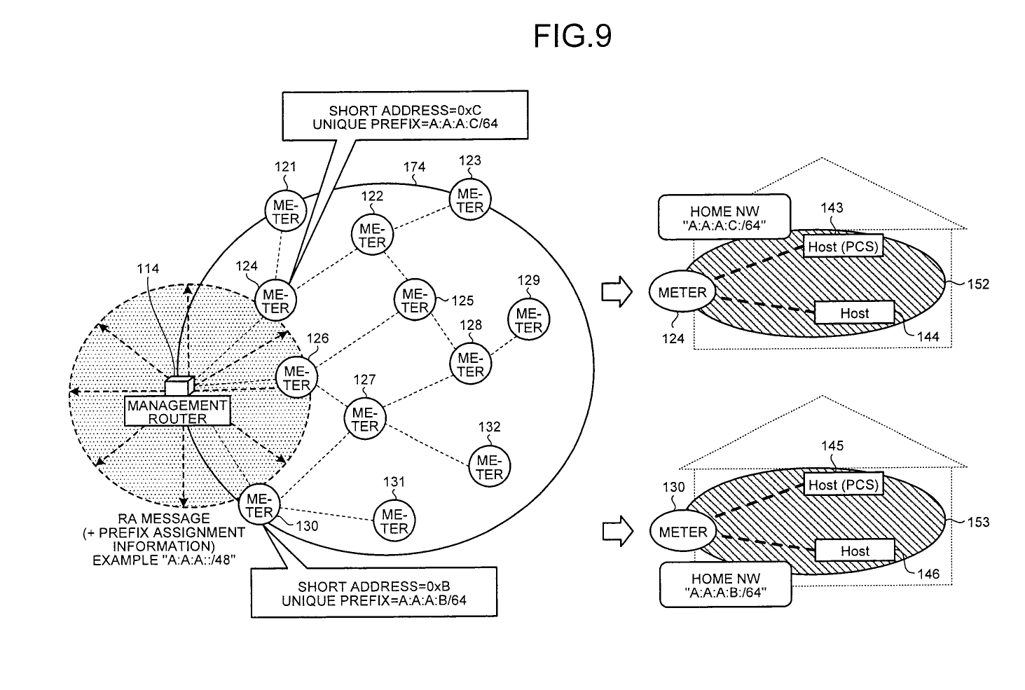

FIG. 9 is a diagram of a configuration example of the network system according to this embodiment. The network system includes a management router 114, meters 121 to 132, and a mesh network 174. In the network system, the management router 114 carries out setting of allocation of short addresses in the meters 121 to 132 and the meters 121 to 132 create, based on prefix delegation information included in an RA message of 6LoWPAN-ND from the management router 114, independent prefixes different from prefixes of the other meters. The configuration of the management router 114 is the same as the configuration of the management routers 111 to 113 in the first embodiment. The configuration of the meter 132 is the same as the meters 121 to 131 in the first embodiment.

The management router 114 operates as a personal area networks (PAN) coordinator and manages short address information usable as a MAC address. Short addresses are addresses independent from the other meters that are set to be allocated to the meters 121 to 132 in the mesh network 174 subordinate to the management router 114 and can be used as addresses of a MAC layer to peculiarly determine the meters. The management router 114 can set to allocate the managed short address information to the subordinate meters.

The short address information managed by the management router 114 is independently set for each of the meters in the mesh network 174 subordinate to the management router 114. In a mesh network subordinate to a different management router, the same short address can be set.

For example, a short address “0xA0” is set in a meter A-1 belonging to a mesh network subordinate to a management router A and a short address “0xA1” different from “0xA0” is set in a meter A-2 belonging to the same mesh network. However, the short address “0xA0” can be set in a meter B-1 belonging to a mesh network subordinate to a management router B.

As the short addresses managed by the management router 114, 16-bit short addresses described in IEEE 802.15.4 can be used. However, the short addresses managed by the management router 114 are not limited to these short addresses. For example, the short addresses can be addresses shorter than or longer than 16 bits and only have to be addresses of a MAC layer that the management router 114 can independently set in the meters 121 to 132 subordinate to the management router 114.

In the management router 114, as a method of setting short addresses in the subordinate meters 121 to 132, MAC Association of MAC Command of IEEE 802.15.4 can be used (Response of MAC association).

The meters 121 to 132 can request the management router 114 to set short addresses. As a method of requesting short address information, MAC Association of MAC Command of IEEE 802.15.4 can be used (Request of MAC Association).

In this way, in the network system according to this embodiment, when the meters 121 to 132 transmit short address requests, the management router 114 receives the short address requests. When short address allocation is possible, the management router 114 can set short addresses in the meters 121 to 132. In the network system, the short addresses can be used as a part of prefix information of an IP layer.

For example, the management router 114 transmits an RA message including prefix delegation information to a 1-Hop neighboring meter. The meter already allocated with a short address and 1-Hop neighboring the management router 114 can combine the received prefix delegation information and an own short address peculiar to the meter to create unique prefix information.

In FIG. 9, when the prefix delegation information included in the RA message from the management router 114 is “A:A:A::/48” and the short address peculiar to the meter 130 is “0xB”, the meter 130 can create unique prefix information “A:A:A:B/64” by attaching the short address peculiar to the meter behind the prefix delegation information. The meter 130 can use the unique prefix information “A:A:A:B/64” for Hosts 145 and 146 connected to the meter 130 in a home network 153. In the case of a short address “0xC” peculiar to the meter 124, the meter 124 can create unique prefix information “A:A:A:C/64” by attaching a short address peculiar to the meter behind the prefix information. The meter 124 can use the unique prefix information “A:A:A:C/64” for Hosts 143 and 144 connected to the meter 124 in a home network 152.

The short addresses allocated to and set in the meters 121 to 132 are peculiar in the mesh network 174. Therefore, the prefix information created by the meters 121 to 132 is independent in the mesh network 174.

The independent prefix information created by the meters can be used as prefix information of a home network connected to the meters, Hosts (home apparatuses), and the like.

After acquiring the prefix delegation information included in the RA message, when transmitting RA messages, the meters 121 to 132 can transmit the RA message while including the same prefix delegation information in the RA message.

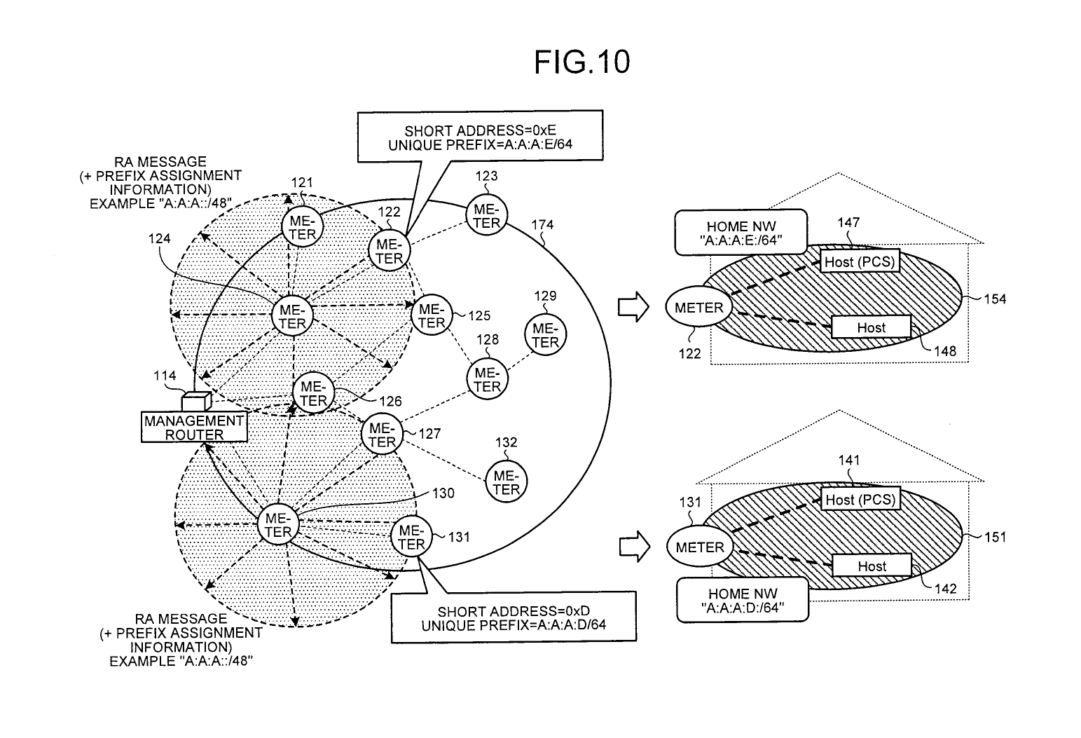

FIG. 10 is a diagram of a configuration example of the network system according to this embodiment. In a state shown in FIG. 10, the meters 124 and 130 receive an RA message including prefix delegation information from the management router 114 and transmit the RA message including the same prefix delegation information.

The meters 124 and 130 acquire prefix delegation information and transmit an RA message to meters 1-Hop neighboring the meters 124 and 130 and not 1-Hop neighboring the management router 114. In the RA message, information same as the prefix delegation information included in the RA message of the management router 114 is included.

Because a short address peculiar to the mesh network 174 is set in the RA message, like the meters 124 and 130, the other meters that receive the RA message from the meters 124 and 130 can combine the prefix delegation information and short addresses peculiar to the meters and create unique prefix information.

In FIG. 10, the prefix delegation information included in the RA message from the meters 124 and 130 is “A:A:A::/48”. Therefore, when the short address peculiar to the meter 122 is “0xE”, the meter 122 can create unique prefix information “A:A:A:E/64” by attaching the short address peculiar to the meter behind the prefix delegation information. The meter 122 can use the unique prefix information “A:A:A:E/64” for Hosts 147 and 148 connected to the meter 122 in a home network 154. When the short address peculiar to the meter 131 is “0xD”, the meter 131 can create unique prefix information “A:A:A:D/64” by attaching the short address peculiar to the meter behind the prefix delegation information. The meter 131 can use the unique prefix information “A:A:A:D/64” for Hosts 141 and 142 connected to the meter 131 in the home network 151.

The independent prefix information created by the meters can be used as prefix information of home networks connected to the meters, Hosts (home apparatuses), and the like.

As explained above, according to this embodiment, the management router allocates a short address to the meter. The meter sets the short address, which is allocated from the management router, as an address of a MAC layer and combines prefix information, the management of which is delegated, and the short address to create prefix information anew. Consequently, the meter can use the new created prefix information as prefix information of a home network.

Even if there is no request from the meter, the management router can also spontaneously allocate a short address to the meter.

### Fifth Embodiment

In a fifth embodiment, in the network system explained in the fourth embodiment, an operation for performing allocation of a short address and prefix delegation between a management router and a 1-Hop neighboring meter of the management router is specifically explained.

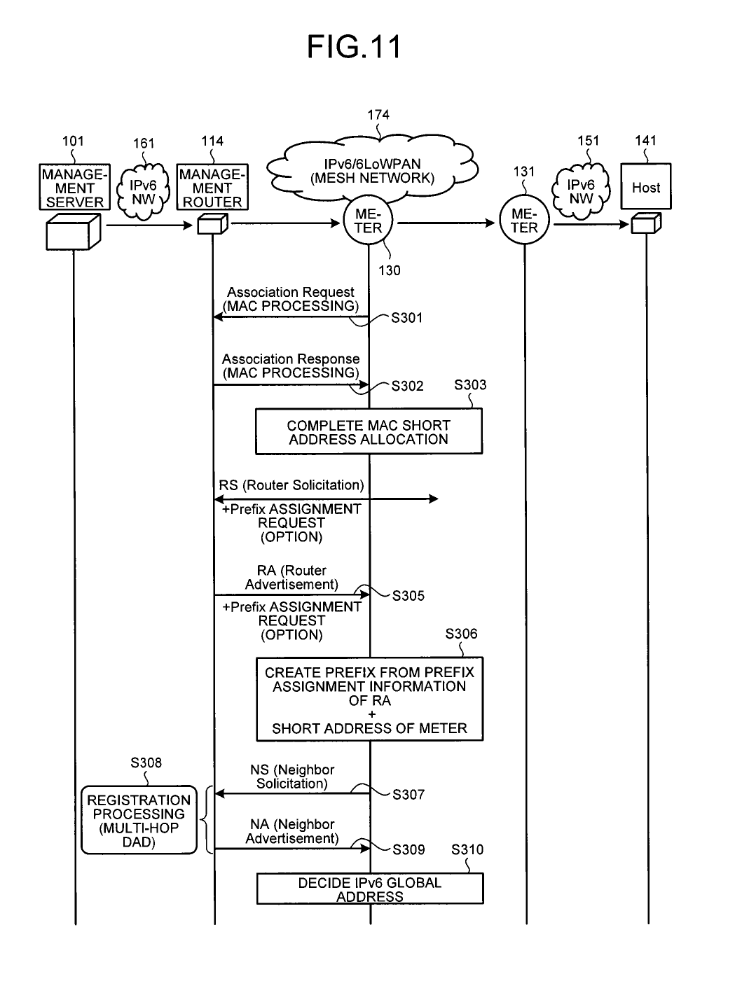

FIG. 11 is a sequence chart for performing notification of a short address and performing notification of prefix delegation information using RS/RA messages of 6LoWPAN-ND between a management router and a 1-Hop neighboring meter. As an example, in the same configuration as FIG. 1, in FIG. 9, allocation of a short address and prefix delegation are performed between the management router 113 and the meter 130 in a flow of communication from the management server 101 not shown in the figure to the management router 114, the meter 130, the meter 131, and the Host 141 not shown in the figure.

First, as processing in a MAC layer, the meter 130 requests the management router 114 to allocate a short address. Allocation processing for a short address can be realized using Association Request and Association Response, which are MAC commands of IEEE 802.15.4.

Specifically, the meter 130 transmits Association Request to the management router 114 (step S301). The management router 114 transmits, as a response to the Association Request, Association Response including an allocated short address to the meter 130 (step S302). The meter 130 receives the Association Response to complete the allocation processing for a short address (step S303).

Subsequently, the 1-Hop neighboring meter 130 transmits an RS message including a prefix delegation request to the management router 114 (step S304). The management router 114 receives the RS message including the prefix delegation request and returns, according to information of the prefix delegation request, an RA message including prefix delegation information to the meter 130 (step S305). The meter 130 receives the RA message including the prefix delegation information and creates, from the prefix delegation information and the short address of the meter 130, an IPv6 prefix peculiar to the meter (step S306).

The meter 130 includes the created prefix information in an NS message and requests the management router 114 to perform registration processing (step S307). The management router 114 receives the request for the registration processing for the prefix information, performs the registration processing (step S308), and transmits an NA message to the meter 130 while including a result of the registration processing (step S309). When an IPv6 address is registered as a result of the registration processing, the meter 130 decides the IPv6 address (step S310).

As explained above, in this embodiment, the meter combines an allocated short address and prefix information included in an RA message to create prefix information anew and requests the management router to perform registration processing using an NS message. The management router transmits an NA message while including a result of the registration processing in the NA message. Consequently, the management router and the 1-Hop neighboring meter can decide and use the new created prefix information.

The NS message and the NA message are used only for the registration processing for an IPv6 global address of the meter 130 itself. However, the use of the NS message and the NA message is not limited to this. When the registration processing for prefix information is not performed, the NS message and the NA message can be used for only a request for a redundancy check.

### Sixth Embodiment

In a sixth embodiment, in the network system explained in the fourth embodiment, an operation for performing allocation of a short address and prefix delegation between a management router and a meter apart from the management router more than 1-Hop is specifically explained.

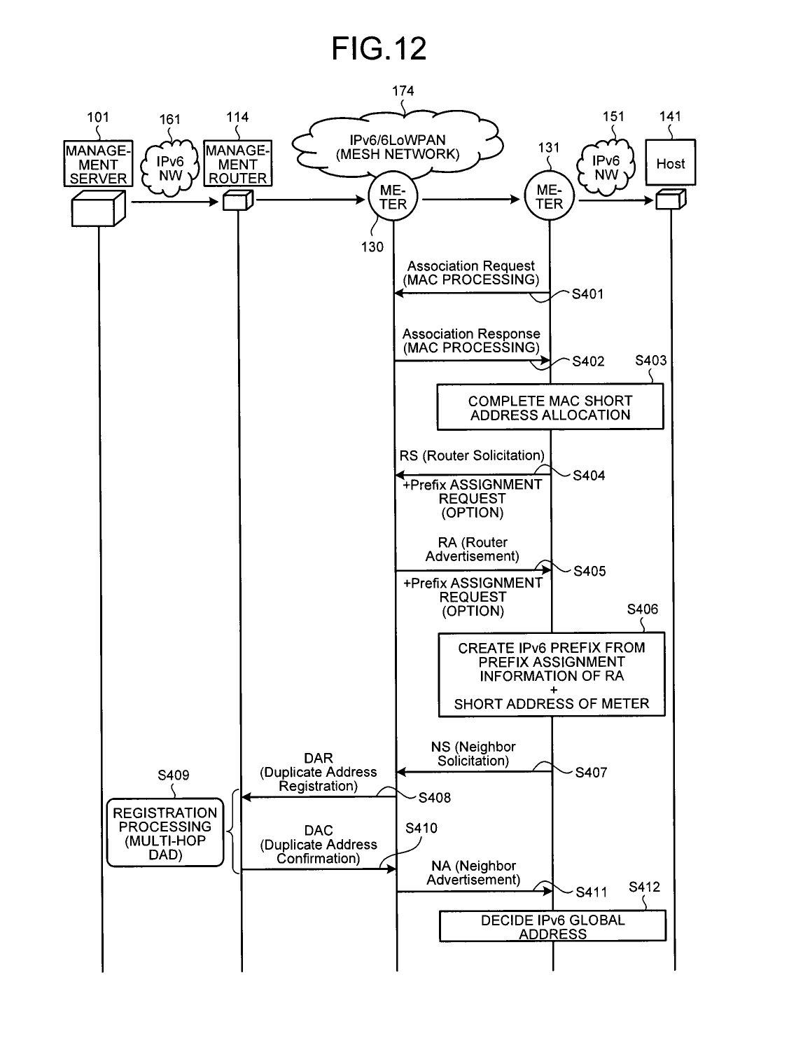

FIG. 12 is a sequence chart for performing notification of a short address and performing notification of prefix delegation information using RS/RA messages of 6LoWPAN-ND. As an example, in the same configuration as FIG. 1, in FIG. 10, allocation of a short address and prefix delegation are performed between the meter 130 and the meter 131 in a flow of communication from the management server 101 not shown in the figure to the management router 114, the meter 130, the meter 131, and the Host 141.

First, as processing in a MAC layer, the meter 131 requests the meter 130 to allocate a short address. Allocation processing for a short address can be realized using Association Request and Association Response, which are MAC commands of IEEE 802.15.4.

Specifically, the meter 130 transmits Association Request to the meter 130 (step S401). The meter 130 transmits, as a response to the Association Request, Association Response including an allocated short address to the meter 131 (step S402). The meter 131 receives the Association Response to complete the allocation processing for a short address (step S403). At this point, the meter 130 that allocates a short address requests in advance the management router 114 or a higher-order meter closer to the management router 114 to allocate a short address used by the meter 130 and a short address allocatable to subordinates. Consequently, the meter allocated with a short address can allocate a short address in response to a short address allocation request from a meter not allocated with a short address.

As a condition, the neighboring meter 130 has already acquired prefix delegation information from the management router 114 or a higher-order meter closer to the management router 114 (from the management router 114 in this processing). The prefix delegation information included in the RA message output by the neighboring meter 130 needs to be the same as the prefix delegation information acquired from the management router 114 or the higher-order meter closer to the management router 114 (the management router 114 in this processing).

The meter 131 transmits an RS message including a prefix delegation request to the meter 130 (step S404). The meter 130 receives the RS message including the prefix delegation request and returns, according to information of the prefix delegation request, an RA message including prefix delegation information to the meter 131 (step S405). The meter 131 receives the RA message including the prefix delegation information and creates, from the prefix delegation information and the short address of the meter 131, an IPv6 prefix peculiar to the meter (step S406).

The meter 131 includes the created prefix information in an NS message and requests, via the meter 130, the management router 114 to perform registration processing using NS/NA and DAR/DAC messages of 6LoWPAN-ND (step S407 to S411). First, the meter 131 includes information concerning an IPv6 prefix in an option of the NS message and requests the meter 130 to perform registration (step S407).

The 1-Hop neighboring meter 130 receives the NS message including the option of the request for the registration processing and further transmits a DAR message to the host management router 114 while including the option of the request for the registration processing included in the NS message in the DAR message instead of the NS message (step S408). The meter 130 multi-hops the DAR message to transmit the DAR message to the management router 114. When the meter 130 is not a 1-Hop neighboring meter, the meter 130 further transmits the DAR message to a higher-order meter.

The management router 114 receives the DAR message attached with the option of the request for the registration processing and performs registration processing for an IPv6 address (step S409).

The management router 114 that executes the registration processing transmits a DAC message, which is a response to the DAR message, to the 1-Hop neighboring meter 130 while including an option of a result of the registration processing for the IPv6 address of the meter 131 in the DAC message (step S410).

The 1-Hop neighboring meter 130 receives the DAC message and transfers an NA message to the meter 131, which transmits the NS message, while including the option of the result of the registration processing in the NA message instead of the DAC message (step S411). When another meter is still present between the meter 130 and the meter 131, because the meter 130 has received a DAR message from the other meter, the meter 130 transfers the DAC message to the meter.

The meter 131 receives the NA message and, when the IPv6 address is registered as a result of the registration processing, decides the IPv6 address (step S412).

At this point, the address registration processing by the NS/NA messages and the DAR/DAC messages can be a sequence of multi-hop DAD by 6LoWPAN-ND. A protocol is not limited as long as the registration processing up to the management router 114 is performed. The NS/NA messages and the DAR/DAC messages are used only for the registration processing for an IPv6 global address of the meter 131 itself. However, the use of the NS/NA messages and the DAR/DAC messages is not limited to this. When the registration processing for prefix information is not performed, the NS/NA messages and the DAR/DAC messages can be used for only a request for a redundancy check.

As explained above, in this embodiment, the meter transmits a DAR message to the management router or the next meter located further on the management router side than the meter while including option information of an NS message received from another meter in the DAR message. The management router detects a request for registration processing included in the option information of the DAR message and transmits, as a response to the request for the registration processing, a DAC message to the meter at the transmission source of the DAR message while including a result of the registration processing in the option information of the DAC message. Consequently, even in a meter apart from the management router more than 1-Hop, it is possible to decide prefix information created anew and use the prefix information.

According to the present invention, there is an effect that it is possible to delegate prefix information in a network having a high packet loss ratio.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A smart meter system adapted to IPv6 comprising:
a management router configured to relay communication between a host network and a subordinate mesh network; and
a plurality of meters configured to establish the mesh network in conjunction with the management router, wherein
the management router performs control for performing a prefix information delegation request for requesting the management server, which is connected through the host network, to delegate management of prefix information of an address usable in the mesh network, receiving, as a response to the prefix information delegation request, prefix information management delegation, which is prefix information in a range of management delegation to the management router, from the management server, and delegating the management of the prefix information within a range of management delegation from the management server in response to a prefix information delegation request from the meter, and
the meter performs control for transmitting a prefix information delegation request to the management router, receiving prefix information management delegation from the management router as a response to the prefix information delegation request, and notifying a home apparatus in a home network connected to the meter of the prefix information, the management of which is delegated from the management router.

2. The smart meter system according to claim 1, wherein the management router and the meter detect, in interfaces respectively connected to the mesh network, option information of a neighbor solicitation (NS) message of ICMPv6, a neighbor advertisement (NA) message, a router solicitation (RS) message, and a router advertisement (RA) message adapted to IPv6 over Low power Wireless Personal Area Networks (6LoWPAN), capable of using Internet Control Message Protocol for IPv6 (ICMPv6), which is a control message, and defined by 6LoWPAN-Neighbor Discovery (ND).

3. The smart meter system according to claim 2, wherein
the meter transmits the NS message of 6LoWPAN-ND while including the prefix information delegation request in option information of the NS message, and
the management router determines the prefix information delegation request included in the option information of the received NS message and, when management can be delegated, returns the NA message while including the prefix information management in option information of the NA message.

4. The smart meter system according to claim 2, wherein
the meter transmits the RS message of 6LoWPAN-ND while including the prefix information delegation request in option information of the RS message, and
the management router determines the prefix information delegation request included in the option information of the received RS message and, when management can be delegated, returns the RA message while including the prefix information management delegation in option information of the RA message.

5. The smart meter system according to claim 2, wherein
the meter includes the option information of the NS message received from another meter in a duplicate address registration (DAR) message and transmits the DAR message to the management router or a next meter located further on the management router side than the meter, and
the management router detects the prefix information delegation request included in the option information of the received DAR message, includes the prefix management delegation in option information of a duplicate address confirmation (DAC) message as a response to the prefix information delegation request and transmits the DAC message to the meter at a transmission source of the DAR message.

6. The smart meter system according to claim 1, wherein the meter transfers a message addressed to another meter, which establishes the mesh network, and a message addressed to the management router.

7. The smart meter system according to claim 1, wherein, when the meter is delegated with the management of the prefix information, if the meter receives the prefix information delegation request from a meter not delegated with the management of the prefix information, the meter delegates the management of the prefix information to the meter that requests delegation of the prefix information.

8. The smart meter system according to claim 1, wherein the management router operates as a coordinator at a top of the mesh network in the mesh network.

9. The smart meter system according to claim 1, wherein, when a plurality of networks are present, the meter can participate in different mesh networks.

10. The smart meter system according to claim 1, wherein the management router includes an interface for the host network and an interface for the mesh network and can use addresses of different protocols in the interfaces.

11. The smart meter system according to claim 1, wherein, when the management router stores the prefix information, the management of which is delegated, and delegates the management of the prefix information to a certain meter, the management router does not delegate the management of the same prefix information to other meters.

12. The smart meter system according to claim 1, wherein, when the management router stores the prefix information, the management of which is delegated, and delegates the management of the prefix information to a certain meter, the management router records time information of the management delegation for each kind of the prefix information and, after the management delegation, does not delegate the management of the same prefix information to other meters before a specified time elapses.

13. The smart meter system according to claim 12, wherein the management router updates the time information when the management router receives, before the specified time elapses, the prefix information delegation request from the meter to which the management of the prefix information is delegated.

14. The smart meter system according to claim 1, wherein
the management router allocates a short address to the meter, and
the meter sets the short address, which is allocated from the management router, as an address of a media access control (MAC) layer, combines the prefix information, the management of which is delegated, and the short address to create prefix information anew, and uses the new created prefix information as prefix information of the home network.

15. The smart meter system according to claim 14, wherein
the meter requests the management router to delegate the short address, and
the management router delegates the short address to the meter as a response to the allocation request for the short address.

16. The smart meter system according to claim 15, where, when the short address is allocated, if the meter receives an allocation request for the short address from a meter to which the short address is not allocated, the meter allocates the short address to the meter that requests allocation of the short address.

17. The smart meter system according to claim 14, wherein
the meter requests the management router to perform registration processing for the new created prefix information, and
the management router performs, based on the request for the registration processing, registration of the prefix information created anew by the meter.

18. The smart meter system according to claim 1, wherein the prefix information is prefix information of an IPv6 global address or prefix information of an IPv6 unique local address.

19. The smart meter system according to claim 1, wherein the mesh network is a wireless mesh network.

20. The smart meter system according to claim 1, wherein, when the meter is connected to the home apparatus, the meter includes an interface for the home network.

21. The smart meter system according to claim 1, wherein the home network is a wireless network.

22. A management router in a smart meter system adapted to IPv6 including the management router configured to relay communication between a host network and a subordinate mesh network and a plurality of meters configured to establish the mesh network in conjunction with the management router,
the management router performing control for performing a prefix information delegation request for requesting the management server, which is connected through the host network, to delegate management of prefix information of an address usable in the mesh network, receiving, as a response to the prefix information delegation request, prefix information management delegation, which is prefix information in a range of management delegation to the management router, from the management server, and delegating the management of the prefix information within a range of management delegation from the management server in response to a prefix information delegation request from the meter.

23. The management router according to claim 22, wherein the management router detects, in an interface connected to the mesh network, option information of a neighbor solicitation (NS) message of ICMPv6, a neighbor advertisement (NA) message, a router solicitation (RS) message, and a router advertisement (RA) message adapted to IPv6 over Low power Wireless Personal Area Networks (6LoWPAN), capable of using Internet Control Message Protocol for IPv6 (ICMPv6), which is a control message, and defined by 6LoWPAN-Neighbor Discovery (ND).

24. The management router according to claim 23, wherein, when the meter transmits the NS message of 6LoWPAN-ND while including the prefix information delegation request in option information of the NS message, the management router determines the prefix information delegation request included in the option information of the received NS message and, when management can be delegated, returns the NA message while including the prefix information management in option information of the NA message.

25. The management router according to claim 23, wherein, when the meter transmits the RS message of 6LoWPAN-ND while including the prefix information delegation request in option information of the RS message, the management router determines the prefix information delegation request included in the option information of the received RS message and, when management can be delegated, returns the RA message while including the prefix information management delegation in option information of the RA message.

26. The management router according to claim 23, wherein, when the meter includes the option information of the NS message received from another meter in a duplicate address registration (DAR) message and transmits the DAR message to the management router or a next meter located further on the management router side than the meter, the management router detects the prefix information delegation request included in the option information of the received DAR message, includes the prefix management delegation in option information of a duplicate address confirmation (DAC) message as a response to the prefix information delegation request and transmits the DAC message to the meter at a transmission source of the DAR message.

27. The management router according to claim 22, wherein the management router operates as a coordinator at a top of the mesh network in the mesh network.

28. The management router according to claim 22, wherein the management router includes an interface for the host network and an interface for the mesh network and can use addresses of different protocols in the interfaces.

29. The management router according to claim 22, wherein, when the management router stores the prefix information, the management of which is delegated, and delegates the management of the prefix information to a certain meter, the management router does not delegate the management of the same prefix information to other meters.

30. The management router according to claim 22, wherein, when the management router stores the prefix information, the management of which is delegated, and delegates the management of the prefix information to a certain meter, the management router records time information of the management delegation for each kind of the prefix information and, after the management delegation, does not delegate the management of the same prefix information to other meters before a specified time elapses.

31. The management router according to claim 30, wherein the management router updates the time information when the management router receives, before the specified time elapses, the prefix information delegation request from the meter to which the management of the prefix information is delegated.

32. The management router according to claim 22, wherein the management router allocates a short address to the meter.

33. The management router according to claim 32, wherein, when the meter requests the management router to delegate the short address, the management router delegates the short address to the meter as a response to the allocation request for the short address.

34. The management router according to claim 32, wherein, when the meter requests the management router to perform registration processing for the new created prefix information, the management router performs, based on the request for the registration processing, registration of the prefix information created anew by the meter.

35. The management router according to claim 22, wherein the prefix information is prefix information of an IPv6 global address or prefix information of an IPv6 unique local address.

36. The management router according to claim 22, wherein the mesh network is a wireless mesh network.

37. A meter in a smart meter system adapted to IPv6 including a management router configured to relay communication between a host network and a subordinate mesh network and a plurality of meters configured to establish the mesh network in conjunction with the management router,
the meter performing control for transmitting a prefix information delegation request to the management router, receiving prefix information management delegation from the management router as a response to the prefix information delegation request, and notifying a home apparatus in a home network connected to the meter of the prefix information, management of which is delegated from the management router.

38. The meter according to claim 37, wherein the meter detects, in an interface connected to the mesh network, option information of a neighbor solicitation (NS) message of ICMPv6, a neighbor advertisement (NA) message, a router solicitation (RS) message, and a router advertisement (RA) message adapted to IPv6 over Low power Wireless Personal Area Networks (6LoWPAN), capable of using Internet Control Message Protocol for IPv6 (ICMPv6), which is a control message, and defined by 6LoWPAN-Neighbor Discovery (ND).

39. The meter according to claim 38, wherein the meter transmits the NS message of 6LoWPAN-ND while including the prefix information delegation request in option information of the NS message.

40. The meter according to claim 38, wherein the meter transmits the RS message of 6LoWPAN-ND while including the prefix information delegation request in option information of the RS message.

41. The meter according to claim 38, wherein the meter includes the option information of the NS message received from another meter in a duplicate address registration (DAR) message and transmits the DAR message to the management router or a next meter located further on the management router side than the meter.

42. The meter according to claim 37, wherein the meter transfers a message addressed to another meter, which establishes the mesh network, and a message addressed to the management router.

43. The meter according to claim 37, wherein, when the meter is delegated with the management of the prefix information, if the meter receives the prefix information delegation request from a meter not delegated with the management of the prefix information, the meter delegates the management of the prefix information to the meter that requests delegation of the prefix information.

44. The meter according to claim 37, wherein, when a plurality of networks are present, the meter can participate in different mesh networks.

45. The meter according to claim 37, wherein, when the management router allocates a short address to the meter, the meter sets the short address, which is allocated from the management router, as an address of a media access control (MAC) layer, combines the prefix information, the management of which is delegated, and the short address to create prefix information anew, and uses the new created prefix information as prefix information of the home network.

46. The meter according to claim 45, wherein the meter requests the management router to delegate the short address.

47. The meter according to claim 46, where, when the short address is allocated, if the meter receives an allocation request for the short address from a meter to which the short address is not allocated, the meter allocates the short address to the meter that requests allocation of the short address.

48. The meter according to claim 45, wherein the meter requests the management router to perform registration processing for the new created prefix information.

49. The meter according to claim 37, wherein the prefix information is prefix information of an IPv6 global address or prefix information of an IPv6 unique local address.

50. The meter according to claim 37, wherein the mesh network is a wireless mesh network.

51. The meter according to claim 37, wherein, when the meter is connected to the home apparatus, the meter includes an interface for the home network.

52. The meter according to claim 37, wherein the home network is a wireless network.
